(19) United States
(12) Patent Application Publication
(10) Pub. No.: US 2017/0061380 A1
(43) Pub. Date: Mar. 2, 2017

(54) COMPUTERIZED SYSTEM AND METHOD FOR CONTROLLING ELECTRONIC DISTRIBUTION OF COMPENSATION

(71) Applicant: ORACLE INTERNATIONAL CORPORATION, Redwood Shores, CA (US)

(72) Inventor: Anadi UPADHYAYA, San Ramon, CA (US)

(21) Appl. No.: 14/837,584

(22) Filed: Aug. 27, 2015

(51) Int. Cl. G06Q 10/10

(52) U.S. Cl. CPC G06Q 10/105

(57) ABSTRACT

Systems, methods, and other embodiments associated with localized compensation approval within a global business are described. In one embodiment, a computer-implemented method includes generating, in an electronic database, an electronic data structure that defines a compensation group comprised of a subset of employee records. The method includes creating a local approval rule that (a) defines criteria that are to be satisfied for approving distribution of compensation to the compensation group and (b) modifies compensation approval for the compensation group from a global approval rule. The method includes applying the local approval rule to the compensation group, in place of the global approval rule, to determine whether the criteria are satisfied for approving the electronic distribution of compensation. The method includes, in response to determining that the local approval rule has been satisfied, electronically distributing the compensation to the compensation group by transmitting an electronic communication indicating approval of the compensation.

### BACKGROUND

Providing compensation to employees in a corporation with global reach is a complex task. The corporation may have dozens of business units spread among different countries and different locations within each country. In many instances, different countries have different norms for distributing compensation and even different laws. Accordingly, a single rule that governs the whole corporation does not provide the appropriate flexibility to manage distribution of compensation.

Consider that, in general, managing employees across separate localities involves many different managers arranged into tiers of a hierarchy. Each successive tier of managers is responsible for approving actions of managers and employees at lower levels. For example, first line managers generally manage specific groups of employees at a specific location while mid and upper level managers may oversee many different groups including lower managers. Accordingly, upper level managers may prefer blanket policies that are implemented for all of the business units. However, such a singular approach to varied local concerns may cause difficulties.

For example, a corporation-wide rule for approving compensation may not be followed due to localized concerns. Thus, in such instances, no rule may be followed. This disparate implementation of corporate management can lead to tracking difficulties, incorrect disbursements, and other inefficiencies because of lacking oversight.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a computing system associated with local approval rules within a business-wide compensation plan.

FIG. 2 illustrates another embodiment of a reporting hierarchy of a business.

FIG. 3 illustrates one embodiment of a method associated with local approval rules within a business-wide compensation plan.

FIG. 4 illustrates an embodiment of a computing system configured with the example systems and/or methods disclosed.

### DETAILED DESCRIPTION

Computerized systems and methods are described herein that control electronic distribution of compensation by using local approval rules to permit flexible enforcement of business-wide compensation approval. For example, a series of managers along a managing hierarchy generally approve compensation to a group of employees before the compensation is distributed. The series of managers may include a first level manager that submits a request for approval to a midlevel manager and so on up the managing hierarchy. This bottom up process can continue until a top level manager provides final approval for the whole business and compensation is finally then distributed.

While approving compensation in this manner provides a simple end-to-end allocation over an entire business, difficulties exist with applying this strict approach across many different business units in a business due to specific needs at the local level. Accordingly, in one embodiment, local approval rules are substituted for different groups to permit flexible compensation approval while maintaining the local approval rule as part of a corporate-wide compensation campaign. In this way, a holistic view of the compensation can be maintained as is provided under the global approval rule while also providing flexible compensation approval for local groups.

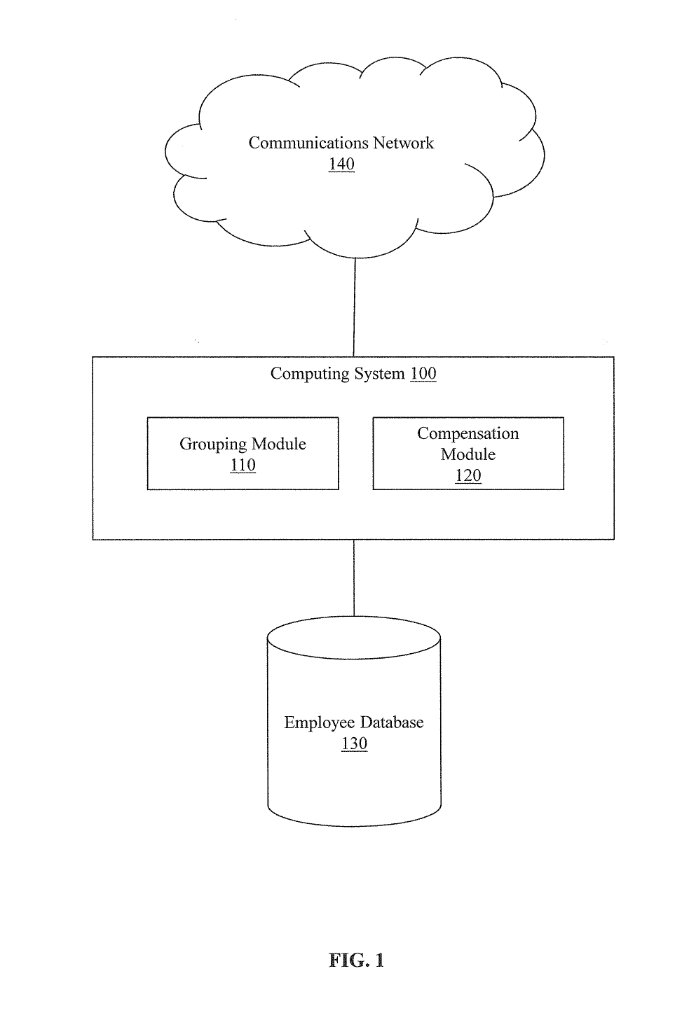

With reference to FIG. 1, one embodiment of a computing system 100 associated with implementing local approval rules for controlling electronic distribution of compensation is illustrated. In one embodiment, the computing system 100 is a computing/data processing system including an application or collection of distributed applications for enterprise organizations. The applications and computing system 100 may be configured to operate with or be implemented as a cloud-based networking system, a software as a service (SaaS) architecture, or other type of networked computing solution. In one embodiment, the computing system 100 is a centralized server-side application that provides at least the functions disclosed herein and that is accessed by many users via computing devices/terminals communicating with the computing system 100 (functioning as the server) over a computer communications network 140.

In one embodiment, one or more of the components described herein are configured as program modules stored in a non-transitory computer readable medium. The program modules are configured with instructions that when executed by at least a processor cause a computing device (e.g., personal computer, server, etc.) to perform the corresponding function(s).

For example, the computing system 100 includes a grouping module 110 and a compensation module 120 that together function to implement local approval rules. In one embodiment, the grouping module 110 and the compensation module 120 configured to receive electronic communications over an electronic communications network 140, analyze and transform the electronic communications into electronic data structures in a database, and generate and modify electronic data structures in an electronic database (e.g., employee database 130) according to applied rules. As a result, the compensation module 120 is configured to control distribution of electronic compensation via electronic transmissions, which includes causing an electronic distribution to be performed (via the network 140) or preventing an electronic distribution to be performed. Thus, the grouping module 110 and the compensation module 120 are tied to the computing system 100 to cause the computing system 100 to perform various novel functions as described herein.

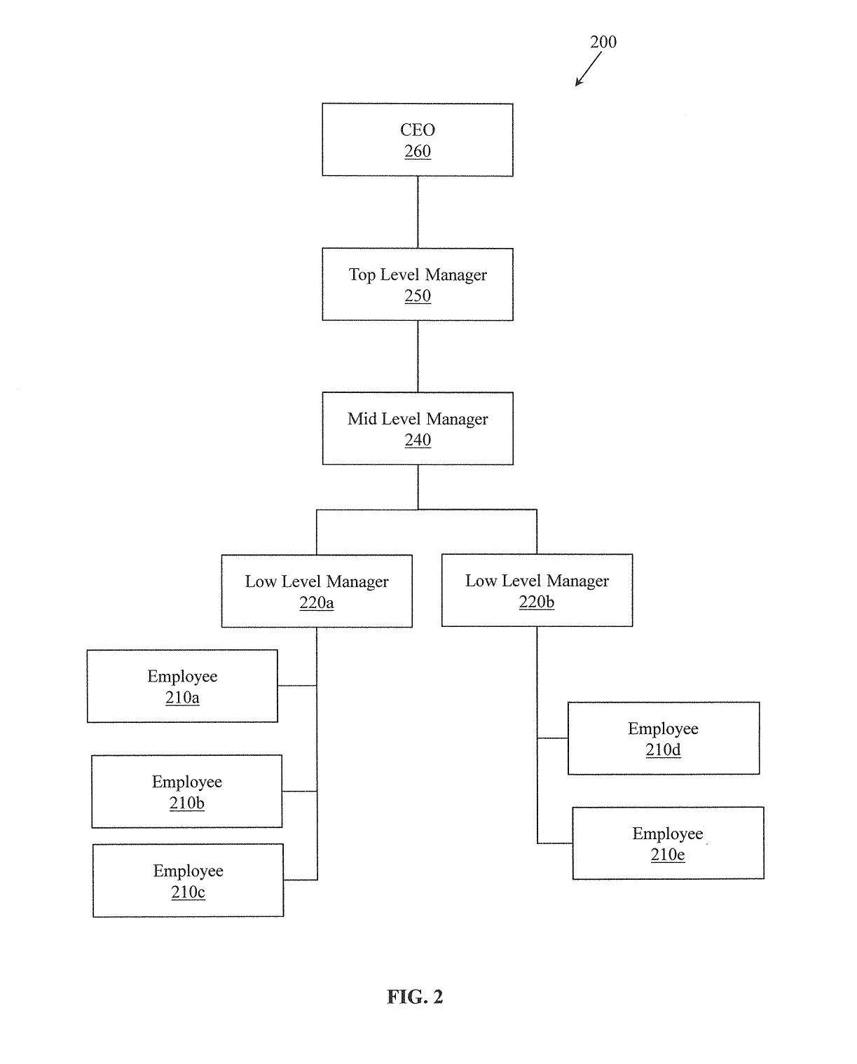

To further define a context within which the computing system 100 may operate, briefly consider FIG. 2. FIG. 2 illustrates one example of a reporting hierarchy 200 associated with a business. The business is, for example, a corporation, Limited Liability Company or some other business organization that includes employees arranged according to managerial relationships. In general, the reporting hierarchy 200 defines managerial relationships between employee records according to a hierarchical tree structure that is stored and maintained electronically. For example, the reporting hierarchy 200 is stored in, for example, the employee database 130. The reporting hierarchy 200 may be stored as an individual separate electronic data structure, may be represented using links between individual employee records and so on. In either case, the reporting hierarchy 200 represents managerial relationships between employee records that are identified according to a managerial level in the reporting hierarchy 200 for the business.

The reporting hierarchy 200 is illustrated with only a single manager at several different managerial levels for purposes of simplifying this discussion. Of course, each separate level of the reporting hierarchy 200 may include many managers each with a different group of employees and managers reporting to them.

Continuing with FIG. 2, the reporting hierarchy 200 is illustrated with employees 210a, 210b, 210c, 210d, and 210e. Employees 210a, 210b and 210c are illustrated with a link to a low level manager 220a while employees 210d and 210e are illustrated with a link to a low level manager 220b. These links illustrate managerial relationships between the employees and their respective low level manager. Additional higher level managerial relationships are further illustrated for each of the low level managers 220a and 220b. For example, the low level manager 220a and 220b report to a mid level manager 240 and, in turn, the mid level manager 240 reports to a top level manager 250. A chief executive officer 260 is located at a root node of the reporting hierarchy 260 since the CEO 260 is, for example, the top officer of the business organization. While a specific set of managers and associated relationships are illustrated, a particular number of managers and employees will vary depending on many factors that are specific to a particular business.

The reporting hierarchy 200 generally illustrates a reporting structure within the business that defines an order review for how decisions are approved. Consider how compensation is approved for the employees 210a-e under a global approval rule, which is a rule that is generally applied to all employees of the business. For the global approval rule, approval progresses from the low level managers 220a-b up through the mid level manager 240 and the top level manager 250, until finally being approved by the CEO 260. The global approval rule is considered satisfied when, for example, each manager along a path to the CEO 260 and the CEO 260 have approved of distributing compensation. Specifics regarding local approval rules will be discussed subsequently. However, it should be appreciated that a local approval rule contrasts with the global approval rule in relation to the scope of an affected group which is limited to a particular group of employees that is a sub-set of the whole (e.g., a related group of employees (employee type), a particular compensation class, employees at a particular location, in a department, or in a division, etc). A local approval rule also differs in the amount of conditions for achieving approval are generally less strict than for achieving a global approval rule.

Returning to FIG. 1 and the computing system 100, in addition to storing the reporting hierarchy 200, the employee database 130 also stores, for example, employee records. In one embodiment, the employee records are electronic data structures that store information about employees of the business. Thus, the employee records generally represent various employees of the business. In one embodiment, the employee database 130 includes a separate employee record for each employee of the business. Thus, the employee records store information (e.g., age, position, location, salary, etc.) regarding the employees of the business in an electronic format.

As explained in relation to the reporting hierarchy 200 of FIG. 2, a local approval rule applies to a subset of employees for the business, whereas the global approval rule is a general rule that applies to all employees. Accordingly, the grouping module 110 generates an electronic data structure that defines a compensation group to which a local approval rule may be applied. In one embodiment, the compensation group is a subset of employees of the business to which a local approval rule is to be applied instead of the global approval rule.

Remember that the global approval rule is a general rule or guideline for defining an approval process to distribute compensation to all employees of an organization. That is, for example, the global approval rule defines which managers and what level of manager is to approve the compensation before the compensation can be distributed. A local approval rule may include elements similar to the global approval rule, but is further defined to apply to a certain group of employees (i.e., the compensation group) and also to have varied criteria from the global approval rule for determining when the local rule is satisfied.

Accordingly, as an initial matter for creating a local approval rule, the grouping module 110 first defines the compensation group. In this way, the grouping module 110 defines a population of employees from the business to which a local approval rule can be applied in order to, for example, accommodate conditions that are specific to the population of employees. Additional aspects of how the compensation group is defined will be discussed in relation to method 300. However, it should be appreciated that, in general, the compensation group is a subset employees in the business for which compensation approval is to be modified from the global approval rule.

The compensation module 120 is configured to create the local approval rule for modifying how compensation approval applies to the compensation group. In one embodiment, the compensation module 120 creates the local approval rule according to criteria that are to be satisfied for approving distribution of compensation to the compensation group. The criteria may include a managerial level of the reporting hierarchy 200 that is to provide approval, a timeframe for providing approval, a number of employees meeting performance requirements and so on.

As an example, consider that the global approval rule specifies that compensation is provided after a manager from each managerial level including the CEO certifies the compensation and that the compensation cannot be distributed prior to the 15^{th} day of each month. However, local laws that govern the employees of a specific location in India dictate that compensation is to be provided on the 1^{st} of each month. Thus, the grouping module 110 initially defines a compensation group to include employees that work at the specific location in India.

Additionally, the compensation module 120 creates a local approval rule according to the criteria of the locality and that also modifies approval to only require the mid level manager 240 certify the compensation prior to distribution. Subsequently, upon the criteria of the local approval rule being satisfied, the compensation module 120 initiates electronic distribution of the compensation to employee records in the compensation group. In this way, the compensation module 120 provides dynamic data entry points to substitute the local approval rule in place of the global approval rule so that flexible approval can be provided to account for specific circumstances relating to the compensation group. Thus, the system and compensation module 120 changes the compensation approval process by applying the local approval rule to the records of the compensation group in place of the global approval rule.

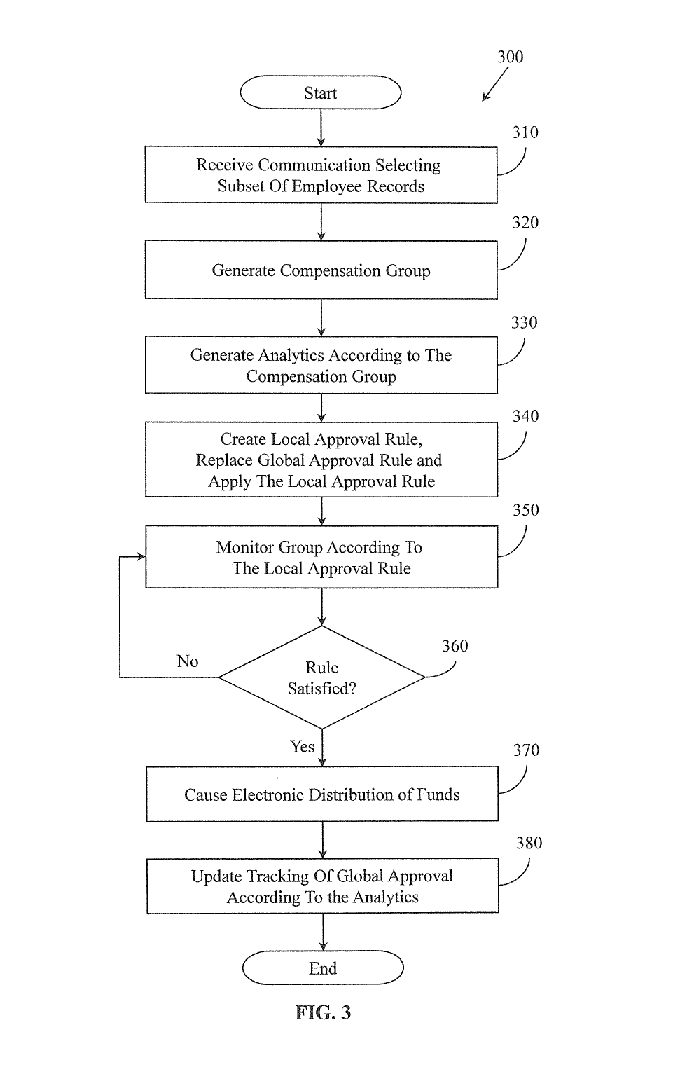

Further aspects of creating local approval rules will be discussed in relation to FIG. 3. FIG. 3 illustrates one embodiment of a method 300 associated with using local approval rules for distributing compensation in a business. For purposes of simplicity, in this discussion, method 300 will be discussed from the perspective of the computing system 100. However, it should be appreciated that method 300 is not limited to being implemented in the computing system 100.

At 310, an electronic communication is received from over a communications network that provides attributes for defining a compensation group. In one embodiment, receiving the electronic communication includes buffering data in an electronic cache memory, identifying data segments that comprise the attributes, and storing the attributes for further analysis.

Furthermore, in one embodiment, the attributes qualify respective employee records to be included in the compensation group without restricting the compensation group by, for example, country or organization unless specifically desired. That is, inclusion in the compensation group is not limited by geographic location, business organization, or even managerial level. In general, the attributes for selecting the members may specify general characteristics or specific employee record identifiers.

For example, the attributes may specify a specific location at which members of the compensation group work, attributes of employees (e.g., age, gender, etc.), a position title, a pay grade, a position category (e.g., programmer, IT staff, etc.) and so on. In general, the attributes for selecting employee records may include any criteria that is known/stored in the employee records.

Briefly referring back to FIG. 2 and the reporting hierarchy 200, consider that the attributes received at 310 specify a particular location of employees to include in the compensation group. In such an instance those included in the compensation group may include, for example, employee 210a, 210d, and 210c along with manager 220b. Thus, the compensation group is generated to include employee records that match with the attributes and without regard to the reporting hierarchy, at physical boundaries, or other factors that may traditionally limit group selection.

Accordingly, at 320, an electronic data structure that defines a compensation group is generated in an electronic database (e.g., the employee database 130). In one embodiment, generating the electronic data structure for the compensation group includes defining a struct, populating the struct with information that specifies members of the compensation group (e.g., listing member identifiers), and storing the populated struct into the electronic database. In one embodiment, instead of a struct, an object instantiated from a programmatic class can be similarly populated and stored.

In general, the computing device 100 generates the compensation group to link employee records of member employees together so that the compensation group may be monitored. Accordingly, the compensation group identifies selected employee records for which a local approval rule is to substitute for the global approval rule. That is, the compensation group identifies a subset of employee records as an exception to the global approval rule, which is otherwise applied to employee records of the business. In this way, the compensation group earmarks particular employee records for the local approval rule to provide flexible approval for compensation outside of the global approval rule.

At 330, the compensation group is analyzed to provide analytics about distributing the compensation to the compensation group. In one embodiment, analyzing the compensation group to provide the analytics includes electronically querying a database for information, compiling a set of statistics about the compensation group, and storing the analytics in the electronic database for further use at a later time.

In one embodiment, the analytics include statistical information about distributing the compensation (e.g., total payout, average payout, number of employees in the compensation group, etc.), information about the compensation group itself (e.g., number of employees) and so on. The analytics can subsequently be provided as an electronic output to one or more managers to facilitate decision making regarding approval of the compensation to the compensation group.

At 340, a local approval rule is created in the electronic database for controlling when compensation is electronically distributed to the compensation group. In one embodiment, creating the compensation rule includes executing one or more commands to generate a data structure, parsing an electronic communication to identify criteria for the local approval rule, populating the data structure with the criteria, defining relationships between the criteria, setting one or more triggers to generate interrupts when the criteria are satisfied, and storing the data structure in the electronic database or another electronic memory for use by the computing device 100.

In one embodiment, the local approval rule defines criteria that are to be satisfied for approving distribution of compensation to the compensation group. As previously discussed, the local approval rule is created to modify compensation approval for the compensation group by replacing the global approval rule. Thus, the system 100 and compensation module 120 change the compensation approval process by applying the local approval rule to the records of the compensation group in place of the global approval rule. Applying the local rule with the defined criteria to the data of the employee records determines whether the criteria is satisfied for approving the electronic distribution of compensation to the compensation group.

In one embodiment, the criteria for satisfying the local approval rule indicate a managerial level of the reporting hierarchy that is to certify the compensation prior to distribution. In another embodiment, the criteria specify timeframes, completions rates, performance indicators or other criteria that may be tracked and used to gauge whether compensation should be approved for the compensation group. In one embodiment, data and values of the defined criteria are electronically read and electronically compared to corresponding values of the employee records and/or other real-time values at the time of executing the approval process. For example, if a criteria value includes a date/time, then current data/time values are compared to the criteria data/time value.

The set of criteria used to define the local approval rule are definable from any tracked metric and/or attribute (e.g., managerial level) associated with the employee records. Furthermore, the criteria may be received in an electronic communication or other electronic input to the computing system 100, automatically defined from information entered into employee records (e.g., location data) and so on.

In either case, the local approval rule is an unstructured rule that provides access to dynamic data entry points for tracking/monitoring employee records according to the criteria of the local approval rule. Accordingly, the local approval rule causes the computing device 100 to modify the approval process and criteria for the compensation group in contrast to the global approval rule. As a result, the local approval rule provides an electronic mechanism for adjusting compensation approval while maintaining a holistic view of analytics for compensation distribution on a business-wide level. That is, even though compensation approval for the compensation group occurs outside of the global approval rule, analytics associated with compensating the compensation group are still, for example, rolled into analytics associated with the global approval rule to maintain the business-wide view of compensation approval.

At 350, the compensation group and one or more associated compensation records are monitored to determine when the local approval rule is satisfied. In one embodiment, monitoring, at 350, includes scanning employee records associated with the compensation group by, for example, electronically traversing the subset of employee records to identify changes associated with the criteria or associated triggering events of the local approval rule. In one embodiment, the monitoring may also include monitoring compensation records (e.g., accounting records) to identify when the criteria are satisfied.

In either case, monitoring the criteria for the local approval rule is, for example, an active task that involves analyzing streams of electronic data to identify when the local approval rule is satisfied. Accordingly, monitoring may also include using the dynamic data entry points to copy the streams of data for analysis to determine when the criteria are satisfied. In this way, the computing system 100 actively applies the local approval rule to detect when the criteria are satisfied.

Therefore, at 360, whether the local approval rule has been satisfied is judged. If the monitoring, at 350, has not yet detected that the criteria have been satisfied, then monitoring continues. However, if the criteria have been satisfied (e.g., an approval flag in the electronic database is activated, an interrupt is activated/generated, etc.), then compensation proceeds at 370.

At 370, in response to determining that the local approval rule has been satisfied for the compensation group, compensation is electronically distributed to the compensation group. In one embodiment, electronically distributing compensation includes transmitting an electronic communication indicating approval that causes the compensation to be transferred to the subset of the employee records. For example, the computing system 100 may electronically transmit a communication to a banking facility that causes funds to be transferred to electronic employee banking accounts of members of the compensation group. In another embodiment, the computing system 100 causes distribution of compensation by modifying employee records of the compensation group. In either case, using the local approval rule to control compensation approval prevents unapproved distributions of compensation in the business while permitting localized approvals that do not follow the global approval rule.

At 380, additional book keeping tasks such as updating statistics associated with the distribution under the local approval rule may occur. In one embodiment, the analytics determined at 330 are used to update analytics of the global approval rule, at 380. In this way, approving compensation under the local approval rule maintains overall records for compensation to the business while still permitting flexibility in approving localized compensation distributions.

Computing Device Embodiment

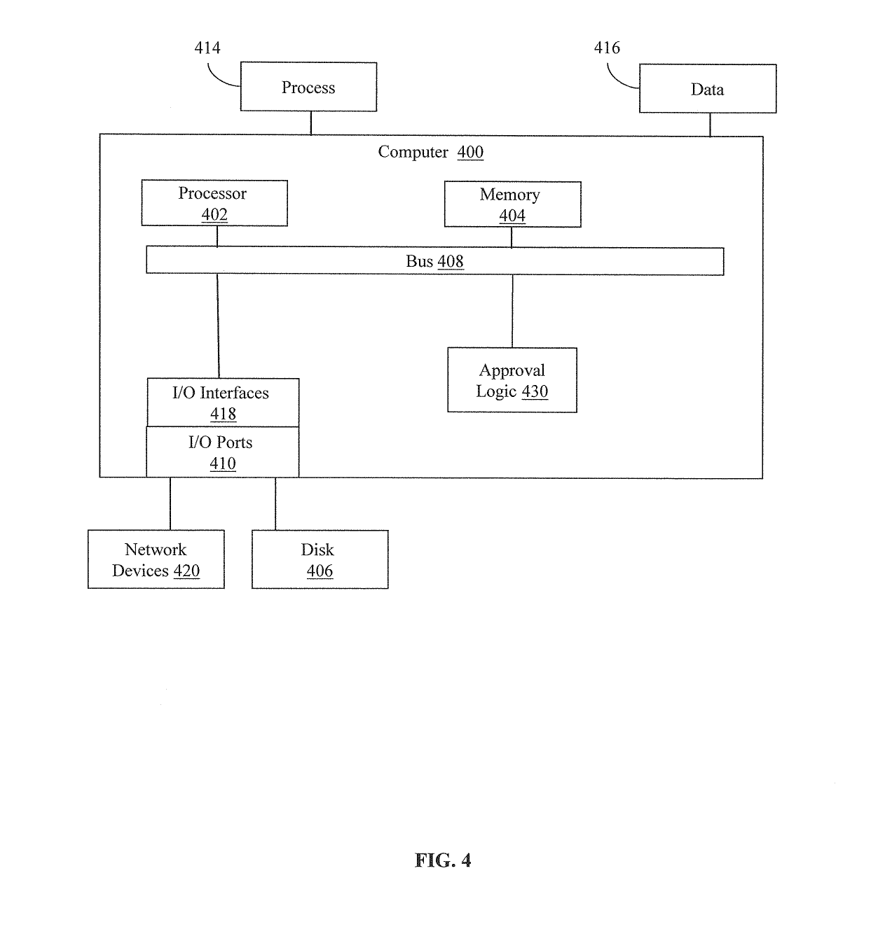

FIG. 4 illustrates an example computing device that is configured and/or programmed with one or more of the example systems and methods described herein, and/or equivalents. The example computing device may be a computer 400 that includes a processor 402, a memory 404, and input/output ports 410 operably connected by a bus 408. In one example, the computer 400 may include approval logic 430 configured to facilitate generating compensation groups, creating local approval rules and distributing compensation according to the local approval rules similar to computing system 100 shown in FIG. 1. In different examples, the approval logic 430 may be implemented in hardware, a non-transitory computer-readable medium with stored instructions, firmware, and/or combinations thereof. While the approval logic 430 is illustrated as a hardware component attached to the bus 408, it is to be appreciated that in other embodiments, the logic 430 could be implemented in the processor 402, stored in memory 404, or stored in disk 406.

In one embodiment, approval logic 430 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to generate compensation groups and local approval rules by modifying electronic data structures of an employee database. The means may also be implemented as stored computer executable instructions that are presented to computer 400 as data 416 that are temporarily stored in memory 404 and then executed by processor 402.

Approval logic 430 may also provide means (e.g., hardware, non-transitory computer-readable medium that stores executable instructions, firmware) for performing electronic distribution of compensation according to a local approval rule.

Generally describing an example configuration of the computer 400, the processor 402 may be a variety of various processors including dual microprocessor and other multi-processor architectures. A memory 404 may include volatile memory and/or non-volatile memory. Non-volatile memory may include, for example, ROM, PROM, and so on. Volatile memory may include, for example, RAM, SRAM, DRAM, and so on.

A storage disk 406 may be operably connected to the computer 400 via, for example, an input/output interface (e.g., card, device) 418 and an input/output port 410. The disk 406 may be, for example, a magnetic disk drive, a solid state disk drive, a floppy disk drive, a tape drive, a Zip drive, a flash memory card, a memory stick, and so on. Furthermore, the disk 406 may be a CD-ROM drive, a CD-R drive, a CD-RW drive, a DVD ROM, and so on. The memory 404 can store a process 414 and/or a data 416, for example. The disk 406 and/or the memory 404 can store an operating system that controls and allocates resources of the computer 400.

The computer 400 may interact with input/output devices via the i/o interfaces 418 and the input/output ports 410. Input/output devices may be, for example, a keyboard, a microphone, a pointing and selection device, cameras, video cards, displays, the disk 406, the network devices 420, and so on. The input/output ports 410 may include, for example, serial ports, parallel ports, and USB ports.

The computer 400 can operate in a network environment and thus may be connected to the network devices 420 via the i/o interfaces 418, and/or the i/o ports 410. Through the network devices 420, the computer 400 may interact with a network. Through the network, the computer 400 may be logically connected to remote computers. Networks with which the computer 400 may interact include, but are not limited to, a LAN, a WAN, and other networks.

### DEFINITIONS AND OTHER EMBODIMENTS

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer software embodied in a non-transitory computer-readable medium including an executable algorithm configured to perform the method.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure,” as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer communication,” as used herein, refers to a communication between computing devices (e.g., computer, personal digital assistant, cellular telephone) and can be, for example, a network transfer, a file transfer, an applet transfer, an email, an HTTP transfer, and so on. A computer communication can occur across, for example, a wireless system (e.g., IEEE 802.11), an Ethernet system (e.g., IEEE 802.3), a token ring system (e.g., IEEE 802.5), a LAN, a WAN, a point-to-point system, a circuit switching system, a packet switching system, and so on.

“Computer-readable medium” or “computer storage medium,” as used herein, refers to a non-transitory medium that stores instructions and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C §101.

“Logic,” as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. §101.

“User,” as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both.” When the applicants intend to indicate “only A or B but not both” then the phrase “only A or B but not both” will be used. Thus, use of the term “or” herein is the inclusive, and not the exclusive use.

The present application incorporates by reference herein, for all purposes, U.S. patent application Ser. Nos. 12/274,847; 12/266,736; 12/209,747; 12/266,804; 12/267,174; 12/254,502; 12/259,452; 13/095,931; 12/365,955; 12/394,361; 12/431,027; 12/578,585; 12/608,090; 12/873,285; 13/235,568; 13/358,861; 13/753,087; 14/500,696; and Ser. No. 14/801,352.

What is claimed is:

1. A non-transitory computer-readable medium storing computer-executable instructions that when executed by a computer cause the computer to perform functions, the instructions comprising:
instructions for generating, in an electronic database, an electronic data structure that defines a compensation group comprised of a subset of employee records that represent a sub-set of all employees of a business;
instructions for creating, in the electronic database, a local approval rule that (a) defines criteria that are to be satisfied for approving the electronic distribution of compensation to the compensation group and (b) modifies compensation approval for the compensation group from a global approval rule that defines conditions for approving the electronic distribution of compensation and that controls electronic distribution of compensation to all employees of the business; and
instructions for, in response to determining that the local approval rule has been satisfied for the compensation group, electronically distributing compensation to the compensation group by transmitting an electronic communication indicating approval of the compensation to cause the compensation to be transferred to the subset of the employee records.

2. The non-transitory computer-readable medium of claim 1, further comprising instructions for:
monitoring, according to the local approval rule, the subset of employee records and one or more compensation records by scanning, using at least a processor, the subset of employee records of the compensation group to identify whether the criteria for the local approval rule have been satisfied, and
wherein scanning includes electronically traversing the subset of employee records in the electronic database to identify changes in the subset of employee records associated with the criteria specified by the local approval rule.

3. The non-transitory computer-readable medium of claim 1, wherein the local approval rule indicates a managerial level of a reporting hierarchy that is to certify the compensation prior to distribution as the criteria, and wherein the global approval rule defines how compensation is distributed within the business based, at least in part, on the reporting hierarchy.

4. The non-transitory computer-readable medium of claim 3, wherein the reporting hierarchy is a hierarchical tree data structure that defines managerial relationships between employee records of the business, and wherein each of the employee records of the business define at least a position in the reporting hierarchy, and wherein electronically distributing compensation to the compensation group prevents unapproved distributions of compensation in the business while permitting localized approvals that do not follow the global approval rule, and wherein the local approval rule controls when compensation is approved for electronic distribution to the compensation group.

5. The non-transitory computer-readable medium of claim 1, further comprising instructions configured for:
receiving an electronic communication over a communications network that specifies attributes for selecting the compensation group from the employee records for the business, and
wherein the attributes indicate attributes that qualify respective employee records to be included in the compensation group.

6. The non-transitory computer-readable medium of claim 1, wherein the instructions for generating the compensation group includes instructions for designating the compensation group as using the local approval rule instead of the global compensation rule, and wherein generating the compensation group includes selecting the subset of the employee records to identify the compensation group as an exception to the global approval rule that specifies how distribution of compensation is approved across the whole business, and wherein the local approval rule provides flexible approval for compensation outside of the global approval rule.

7. The non-transitory computer-readable medium of claim 1, further comprising instructions configured for:
analyzing the compensation group to provide analytics regarding distribution of the compensation to the compensation group, wherein the analytics include a number of employees in the compensation group and statistics about the compensation group.

8. The non-transitory computer-readable medium of claim 7, further comprising instructions for:
updating statistics associated with the global approval rule according to the analytics of the local approval rule to maintain overall records for compensation within the business.

9. The non-transitory computer-readable medium of claim 1, further comprising instructions configured for:
receiving an electronic communication over a communications network that specifies attributes for selecting the compensation group from the employee records for the business, wherein the attributes indicate attributes that qualify respective employee records to be included in the compensation group;
analyzing the compensation group to provide analytics regarding distribution of the compensation to the compensation group, wherein the analytics include a number of employees in the compensation group and statistics about the compensation group;
monitoring, according to the local approval rule, the subset of employee records and one or more compensation records by scanning, using at least a hardware processor, the subset of employee records of the compensation group to identify whether the criteria for the local approval rule have been satisfied, and
wherein scanning includes electronically traversing the subset of employee records in the electronic database to identify changes in the subset of employee records associated with the criteria specified by the local approval rule,
wherein the local approval rule indicates a managerial level of a reporting hierarchy that is to certify the compensation prior to distribution as the criteria, and wherein the global approval rule defines how compensation is distributed across the business according to the reporting hierarchy, wherein the reporting hierarchy is a hierarchical tree data structure that defines managerial relationships between employee records of the business, wherein each of the employee records of the business define at least a position in the reporting hierarchy,
wherein generating the compensation group includes designating the compensation group as using the local approval rule instead of the global compensation rule, and wherein generating the compensation group includes selecting the subset of the employee records to identify the compensation group as an exception to the global approval rule that specifies how distribution of compensation is approved across the whole business, and wherein the local approval rule provides flexible approval for compensation outside of the global approval rule; and
updating statistics associated with the global approval rule according to the analytics of the local approval rule to maintain overall records for compensation within the business.

10. A computing system, comprising:
a grouping module stored in a non-transitory computer readable medium and configured with instructions for generating, in an electronic database, an electronic data structure that defines a compensation group comprised of a subset of employee records that represent employees of a business;
a compensation module stored in a non-transitory computer readable medium and configured with:
instructions for creating, in the electronic database, a local approval rule that (a) defines criteria that are to be satisfied for approving distribution of compensation to the compensation group and (b) modifies compensation approval for the compensation group from a global approval rule, and
instructions for electronically distributing, in response to determining that the local approval rule has been satisfied, compensation to the compensation group by transmitting an electronic communication indicating approval of the compensation to cause the compensation to be transferred to the subset of the employee records.

11. The computing system of claim 10, wherein the compensation module further includes instructions for:
monitoring, according to the local approval rule, the subset of employee records and one or more compensation records by scanning, using at least a hardware processor, the subset of employee records of the compensation group to identify whether the criteria for the local approval rule have been satisfied, and
wherein scanning includes electronically traversing the subset of employee records in the electronic database to identify changes in the subset of employee records associated with the criteria specified by the local approval rule.

12. The computing system of claim 10, wherein the local approval rule indicates a managerial level of a reporting hierarchy that is to certify the compensation prior to distribution as the criteria, and wherein the global approval rule defines how compensation is distributed across the business according to the reporting hierarchy,
wherein the reporting hierarchy is a hierarchical tree data structure that defines managerial relationships between employee records of the business, and wherein each of the employee records of the business define at least a position in the reporting hierarchy,
wherein electronically distributing compensation to the compensation group prevents unapproved distributions of compensation in the business while permitting localized approvals that do not follow the global approval rule, and
wherein the local approval rule controls when compensation is distributed to the compensation group.

13. The computing system of claim 10, wherein the grouping module further includes instructions for:
receiving an electronic communication over a communications network that specifies attributes for selecting the compensation group from the employee records for the business,
wherein the attributes indicate attributes that qualify respective employee records to be included in the compensation group.

14. The computing system of claim 10, wherein the compensation module further includes instructions for:
analyzing the compensation group to provide analytics regarding distribution of the compensation to the compensation group, wherein the analytics include a number of employees in the compensation group and statistics about the compensation group; and
updating statistics associated with the global approval rule according to the analytics of the local approval rule to maintain overall records for compensation within the business, wherein generating the compensation group includes selecting the subset of the employee records to identify the compensation group as an exception to the global approval rule that specifies how distribution of compensation is approved across the whole business, and wherein the local approval rule provides flexible approval for compensation outside of the global approval rule.

15. A computer-implemented method performed by a computing device including at least a processor that executes instructions from a memory, the method comprising:
generating, in an electronic database, an electronic data structure that defines a compensation group comprised of a subset of employee records that represent employees of a business;
creating, in the electronic database, a local approval rule that (a) defines criteria that are to be satisfied for approving distribution of compensation to the compensation group and (b) modifies compensation approval for the compensation group from a global approval rule;
applying the local approval rule to the compensation group, in place of the global approval rule, to determine whether the criteria are satisfied for approving the electronic distribution of compensation to the compensation group; and
in response to determining that the local approval rule has been satisfied, electronically distributing the compensation to the compensation group by transmitting an electronic communication indicating approval of the compensation to cause the compensation to be transferred to the subset of the employee records.

16. The computer-implemented method of claim 15, further comprising:
monitoring, according to the local approval rule, the subset of employee records and one or more compensation records by scanning, using at least a hardware processor, the subset of employee records of the compensation group to identify whether the criteria for the local approval rule have been satisfied, and
wherein scanning includes electronically traversing the subset of employee records in the electronic database to identify changes in the subset of employee records associated with the criteria specified by the local approval rule.

17. The computer-implemented method of claim 15, wherein the local approval rule indicates a managerial level of a reporting hierarchy that is to certify the compensation prior to distribution as the criteria, and wherein the global approval rule defines how compensation is distributed across the business to the employee records based, at least in part, on the reporting hierarchy, wherein the reporting hierarchy is a hierarchical tree data structure that defines managerial relationships between employee records of the business, wherein each of the employee records of the business define at least a position in the reporting hierarchy.

18. The computer-implemented method of claim 15, wherein generating the compensation group includes designating the compensation group as using the local approval rule instead of the global compensation rule, and wherein generating the compensation group includes selecting the subset of the employee records to identify the compensation group as an exception to the global approval rule that specifies how distribution of compensation is approved across the whole business, and wherein the local approval rule provides flexible approval for compensation outside of the global approval rule, and wherein the local approval rule controls when compensation is electronically distributed to the compensation group, and wherein electronically distributing the compensation to the compensation group prevents unapproved distributions of compensation in the business while permitting localized approvals that do not follow the global approval rule.

19. The computer-implemented method of claim 15, further comprising:
analyzing the compensation group to provide analytics regarding distribution of the compensation to the compensation group, wherein the analytics include a number of employees in the compensation group and statistics about the compensation group.

20. The computer-implemented method of claim 15, further comprising:
updating statistics associated with the global approval rule according to analytics of the local approval rule to maintain overall records for compensation within the business.
